(19) United States
(12) Patent Application Publication
(10) Pub. No.: US 2008/0118268 A1
(43) Pub. Date: May 22, 2008

(54) METHOD OF COARSE CALIBRATION OF THE PACKER SENSOR USING A ZERO % TC READING

(75) Inventors: Mark A. Scheuer, Williamson, NY (US); Mark S. Petrush, Webster, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/561,187

(22) Filed: Nov. 17, 2006

(51) Int. Cl. G03G 15/00

(52) U.S. Cl. 399/74

(57) ABSTRACT

A method for calibrating a toner concentration sensor may include obtaining a zero % TC reading from the toner concentration sensor using a carrier material, determining an estimated TC intercept, and adjusting the toner concentration sensor based on the estimated TC intercept. An apparatus for calibrating a toner concentration sensor may include a toner concentration sensor that detects toner concentration of a developer mix in a developer cartridge and a toner concentration sensor controller that applies calibration to the toner concentration sensor. The toner concentration sensor controller mat include a toner concentration sensor reading section that obtains a zero % TC reading of the toner concentration sensor based on the carrier material, a toner concentration sensor correcting section that determines an estimated TC intercept, and an adjusting section that determines for the calibration for the toner concentration sensor based on the estimated TC intercept.

### BACKGROUND

This invention relates to a method and an apparatus for calibrating a toner concentration sensor. In particular, this invention relates to a method for calibrating a toner concentration sensor using zero % TC reading, for example, when a fresh supply of carrier granules is to be used.

In xerographic printing machines, a developer mix is supplied in a developer housing, which mixes toner particles with coarse carrier granules. The toner particles and carrier granules as supplied are mixed at an appropriate toner concentration such that the toner particles acquire the appropriate charge relative to a electrostatic latent image recorded on the photoconductive surface. The toner concentration (TC) is monitored by a toner concentration sensor to provide an appropriate toner mixture.

The toner concentration sensor may be calibrated periodically, as needed. In particular, the toner concentration sensor needs to be calibrated when the developer material is initially installed in a housing or if the material needs to be replaced during a service action. In such a case, an operator may simply reset the toner concentration sensor to a nominal level. Alternatively, the operator may use an optical tool for calibration. Using the optical tool, the operator may draw a sample from the developer housing and measure the toner concentration of the developer mix. Then, a lookup table may be used to adjust an intercept for the toner concentration sensor so that the reading of the toner concentration sensor matches the measured value.

### SUMMARY

However, using only the optical tool is inefficient and may be insufficient. Therefore, it is desired to calibrate the toner concentration sensor more efficiently and accurately. However, because the sensor does not know an appropriate concentration, for example, for a new supply of material, it is difficult to precisely calibrate the toner concentration sensor.

In particular, the toner concentration sensor may be calibrated by using a zero % TC reading of the toner concentrate sensor and calculating an estimated TC intercept based on the zero % TC reading.

In exemplary embodiments, a method for calibrating a toner concentration sensor may include obtaining a zero % TC reading from the toner concentration sensor based on a carrier material, determining an estimated TC intercept, and pre-calibrating the toner concentration sensor based on the estimated TC intercept.

Furthermore, in exemplary embodiments, an apparatus for calibrating a toner concentration sensor may include a toner concentration sensor that detects toner concentration of a developer mix in a developer housing and a toner concentration sensor controller that applies calibration to the toner concentration sensor. The toner concentration sensor controller may include a toner concentration sensor reading section that obtains a zero % TC reading of the toner concentration sensor based on a carrier material, a toner concentration sensor correcting section that determines an estimated TC intercept, and a pre-calibrating section that determines for the calibration for the toner concentration sensor based on the estimated TC intercept.

The apparatus may further include a housing detecting section that detects when new carrier without toner is installed in the developer housing. The toner concentration sensor reading section may obtain the zero % TC reading after the developer installation detection section detects the new carrier. Once the zero % TC reading is taken and the TEC intercept is estimated, the system can then use the TC sensor to raise the housing toner concentration to its proper operating point.

### BRIEF DESCRIPTION OF THE DRAWINGS

FIG. 1 is a schematic diagram of an exemplary digital imaging system;

FIG. 2 is a diagram showing an exemplary developer cartridge at which a toner concentration sensor is provided;

FIG. 3 is an exemplary block diagram of the toner concentration sensor and a toner concentration sensor controller; and

FIG. 4 is an exemplary flow chart illustrating processes to calibrate the toner concentration sensor.

### DETAILED DESCRIPTION OF EMBODIMENTS

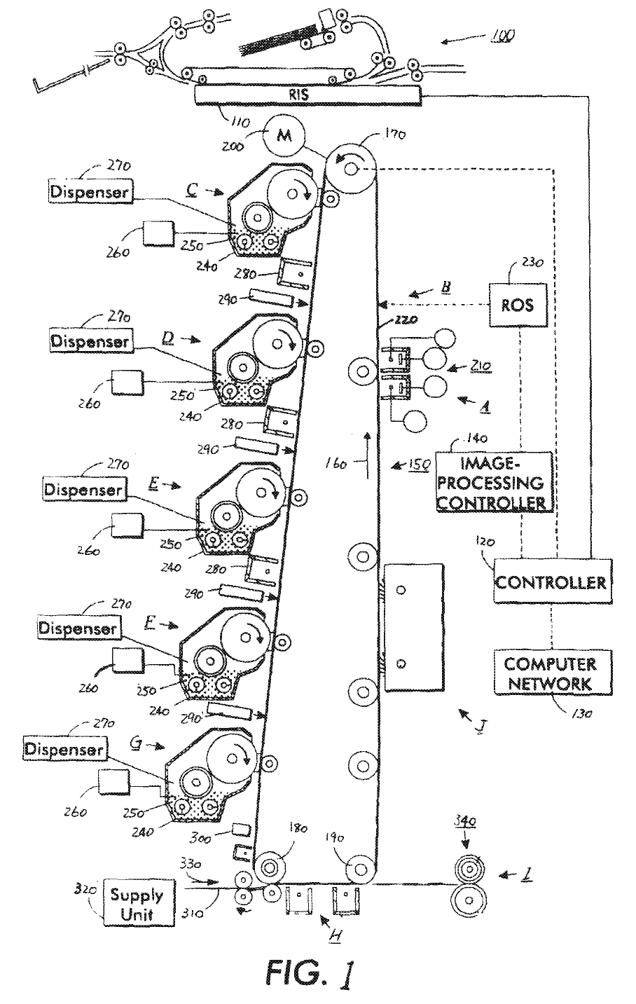

With reference to the Figures, exemplary embodiments are directed to a method and an apparatus for calibrating a toner concentration sensor. FIG. 1 is a schematic view of an exemplary color digital imaging system, such as a xerographic printing machine. In this example, an original document is placed in a document handler 100 on a raster-input scanner (RIS) 110. It should be understood that other types of scanners may be substituted for RIS 110. The RIS 110 scans the original document to generate a series of raster scan lines or image signals containing document information. These image signals may be transmitted to an electronic subsystem (ESS) or controller 120. Alternatively, image signals may be transmitted from another source though a computer network 130 to the controller 120. The controller 120 can be implemented using a special purpose computer, a programmed microprocessor or microcontroller and peripheral integrated circuit elements, and ASIC or other integrated circuit, a digital signal processor, a hardware electronic or logic circuit, such as a discrete element circuit, a programmable logic device, such as PLD, PLA, FPGA or PAL, or the like.

The computer network 130 can be any known or later developed device or system for transmitting image signals to the controller 120, including a direct cable connection, a connection over a wide area network or a local area network, a connection over an intranet, a connection over the Internet, or a connection over any other distributed processing network or system.

A photoreceptor belt 150 may be supported for movement in a direction indicated by arrow 160. The photoreceptor belt 150 may be moved by a drive roller 170, a tension roller 180 and a fixed roller 190. The drive roller 714 may be connected to and driven by a drive motor 200 to drive the photoreceptor belt 150. A portion of the photoreceptor 150 may pass through a charging station A, in which a corona generating device 210 charges the photoconductive surface of the photoreceptor belt 150 to a relatively high, substantially uniform potential.

After passing the charging station A, the charged portion of photoconductive surface 220 may be advanced through an imaging/exposure station B. At the imaging/exposure station B, the controller 120 receives the image signals consisting the document information transmitted from raster input scanner 110 or computer network 130 and processes the image signals to convert them to the various color separations of the image. The desired output image may be transmitted to a Raster Output Scanner (ROS) 230, which causes the charged surface to be discharged in accordance with the output from the scanning device.

An image-processing controller 140 receives the document information from the controller 120 and converts this document information into electrical signals for the raster output scanner 230. The image-processing controller 140 can be implemented using a special purpose computer, a programmed microprocessor or microcontroller and peripheral integrated circuit elements, and ASIC or other integrated circuit, a digital signal processor, a hardware electronic or logic circuit, such as a discrete element circuit, a programmable logic device, such as PLD, PLA, FPGA or PAL, or the like.

Each of development stations C-G may include a developer structure 240. The developer structure 240 may contain toner particles 250 of a color, such as magenta. The developer structure 240 may cause charged toner particles 250 to be attracted to the electrostatic latent image. A toner concentration sensor 260 may sense the toner concentration in the developer structure 240. A dispenser 270, which is controlled by the controller 120, may dispense toner or the color into the developer structure 240 to maintain a proper toner concentration based on detection of the toner concentration sensor.

The photoreceptor belt 150 having the developed, unfixed image may then be transported to a second charging device 280 where the photoreceptor belt 150 and the developed toner image areas may be recharged to a predetermined level. An output device 290 performs a second exposure/imaging. The output device 290 may be utilized for selectively discharging the photoreceptor belt 150, based on the image to be developed with the second color toner. The output device 290 may be a raster output scanner controlled by the controller 120.

The above procedure may be repeated for different stations for different colors using the same or similar structures. In addition, the dispensers 270 may be the same or similar in structure. In this manner a full color composite toner image may be developed on the photoreceptor belt 150. In addition, a permeability sensor 300 may measure developed mass per unit area (developability). Although only one sensor 300 is shown in FIG. 1, there may be more than one sensor 300.

After the image development in each color, a recording material 310, such as paper, from a supply unit 320 may be moved into contact with the toner images at transfer station H. The recording material 310 may be advanced to a transfer station H by the supply unit 320 in the direction of arrow 330. The recording material 310 is then brought into contact with the photoconductive surface 220 of photoreceptor belt 150 in a sequence so that the toner image developed on the photoconductive surface 220 contacts the recording material 310 at the transfer station H.

After the toner image on the photoconductive surface 220 of the photoreceptor belt 15 is transferred onto the recording material 310, the recording material 310 may continue to move to a fusing station I. The fusing station H may include a fuser assembly 340, which permanently affixes the transferred image to the recording material 310. The toner images are therefore affixed to the recording material 310.

As the recording material 28 is separated from the photoconductive surface 220 of the photoreceptor belt 150, the residual toner particles carried by the non-image areas on the photoconductive surface may be removed. These particles may be removed at the cleaning station J using cleaning brushes 350 in a housing 360. The cleaning brushes 350 may be engaged after the composite toner image is transferred to a sheet. Once the photoreceptor belt 150 is cleaned, the cleaning brushes 350 may be retracted utilizing a device incorporating a clutch (not shown) so that the next imaging and development cycle can begin.

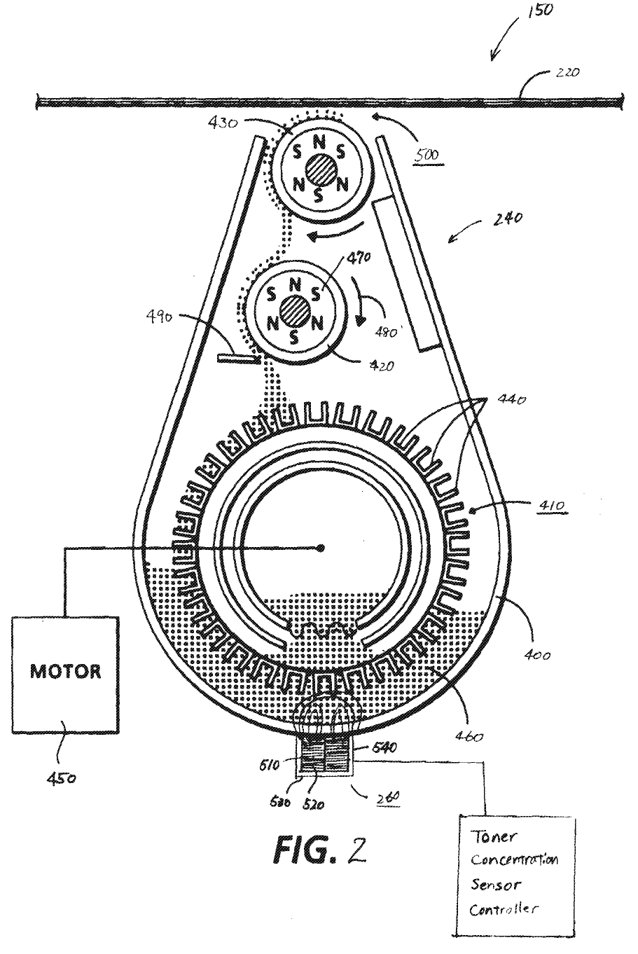

As shown in FIG. 2, the developer structure 240 may include a developer housing 400, a paddle wheel 410, a donor roll 420 and a magnetic brush 430. The paddle wheel 410 may include scoops 440 disposed about the periphery of the paddle wheel 410. As the paddle wheel 410 rotates by a motor 450, a developer mix 460 may be elevated from a lower part of the developer housing 400 to the upper region. When the developer mix 460 reaches the upper region of the developer housing 400, the developer mix 460 may be lifted from scoops 440 to the donor roll 420.

As the developer mix 460 in the scoops 440 approaches the donor roll 420, the magnetic field produced by magnets 470 of the donor roll 420 may attract the developer mix 460. The donor roll 420 may move the developer mix 460 toward the donor roll 420 and may be rotated in a direction of an arrow 480. Excess developer mix may be removed from the donor roll 420 by a blade 490. The blade 490 may be positioned to shear the excess developer mix 460 from the donor roll 420 so that the excess developer mix 460 returns to the paddle wheel 410. The developer mix 460 may then be transferred to a development zone 500 located between the photoconductive surface 2203 of photoreceptor 150 and the magnetic brush 430. The electrostatic latent image recorded on the photoreceptive surface 220 may be developed by contacting the developer mix 460 and attracting the toner particles.

The toner concentration sensor 260 may be provided at the developer housing 400 and may include a sensor 510 to detect the toner concentration of the developer mix 460 by generating a magnetic field. The sensor 510 of the toner concentration sensor 460 may include a wire 520 wrapped around a core 530. A portion of the sensor 510 may be accommodated by a shield 540. The shield 540 may include a slit (not shown) to minimize eddy current generation around the sensor 520. The toner concentration sensor 260 may be connected to a toner concentration sensor controller 550. The toner concentration sensor controller 550 may control calibration of the toner concentration sensor 260 periodically or when the toner concentration sensor controller 550 needs to be calibrated. When the developer mix 460 is replaced, for example, with a new one, the toner concentration sensor 260 needs to be calibrated to accurately detect the toner concentration for the new developer mix.

An example of a toner concentration sensor is described in U.S. Pat. No. 5,166,729 to Rathburn et al, which is incorporated herein by reference in its entirety.

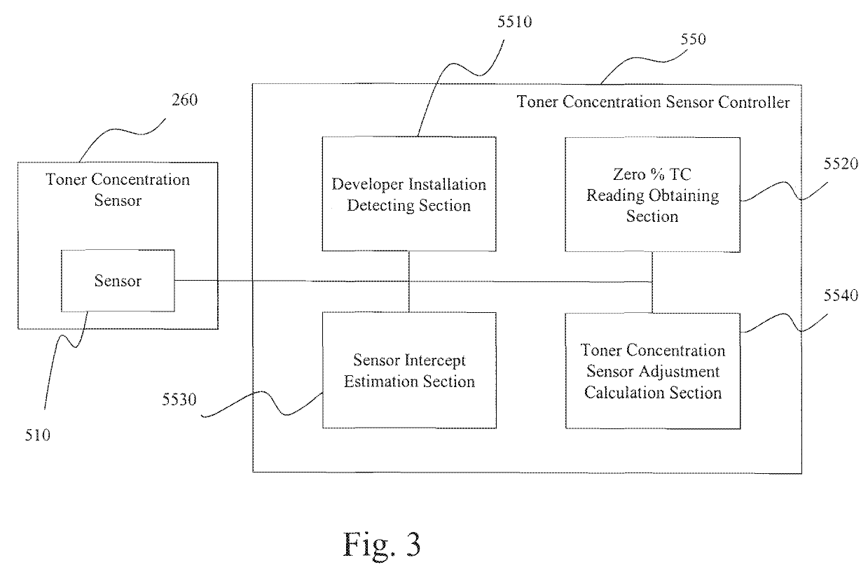

FIG. 3 is a block diagram of an exemplary system configured to calibrate the toner concentration sensor 260 using the toner concentration sensor controller 550. The toner concentration sensor controller 550 may include a developer installation detecting section 5510, a zero % TC reading obtaining section 5520, a sensor intercept estimation section 5530, and a toner concentration adjustment section 5540. Using the developer replacement section 5510, the toner concentration sensor controller 550 may detect a supply of a developer material when the developer material is installed in a developer housing. The developer material may include a supply of fresh carrier without toner. When the developer is installed, the zero % TC reading obtaining section 5520 obtains a zero % TC reading of the sensor 510 of the toner concentration sensor 260 before the toner is added. The zero % TC is the concentration of the carrier material with no toner mixed therewith. Then, based on the obtained zero % TC reading, a sensor intercept is estimated by the sensor intercept estimation section 5530 and stored in a memory. The estimated TC intercept may be determined by dividing the zero % TC reading by a first predetermined value and subtracting a second predetermined value from the division. The first and second predetermined values may be determined based on the carrier and/or toner characteristics. Such values may be determined by experiments performed during the development of the algorithm for the carrier materials. For example, the values may be determined by detoning or retoning the developer materials to determine the average intercept for the carrier material. Then, based on the estimated TC intercept, after the toner is mixed with the carrier, the toner concentration adjustment section 5540 adjusts the toner concentration while mixing with the carrier so that the toner concentration becomes to a configured percentage, such as 6.5%.

For example, if a value at zero % TC reading of the toner concentration sensor 260 at the time when a new carrier is supplied is 1624 Ptics, and if the first and second predetermined values are 0.88 and 139.15 based on a test, then the estimated intercept is 1706 Ptics. The Ptics may be determined by measuring the inductance time decay of an applied current of 0.5 A, which is shut off at the start of the time measurement, and determining the length of time needed for the induced current to drop to 0.1 A. Using the estimated TC intercept in the memory, the toner concentration adjustment instructing section 5540 may calibrate tone of the sensor 510 of the toner concentration sensor 260. The calibrated toner concentration sensor 260 may be further adjusted by an optical tool for more precise calibration. Such an optical tool is described in U.S. Patent Publication No. 2006/0104654 to Borton et al., which is incorporated by reference in its entirety.

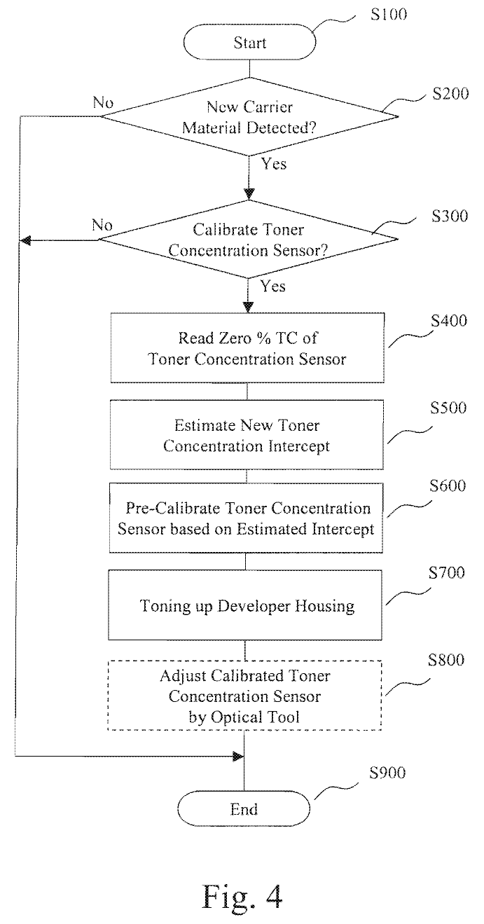

FIG. 4 is an exemplary flow chart illustrating a method of calibrating the toner concentration sensor. The process starts at step S100 and continues to step S200. At step S200, a detection may be made as to whether new carrier is supplied. The new carrier may be supplied when a new cartridge is installed. If so, the process continues to step S300, otherwise the process jumps to step S800 to end. At step S300, a determination may be made as to whether the toner concentration sensor needs to be calibrated. If so, the process continues to step S400, otherwise the process jumps to step S800 to end.

At step S400, with the new carrier without toner, a zero % TC reading may be obtained from the toner concentration sensor. Then, at step S500, a new toner concentration intercept may be estimated by dividing the zero % TC reading by a first predetermined value and subtracting a second predetermined value from the division. The estimated intercept may be then put into a memory. At step S600, based on the estimated intercept, the toner concentration is pre-calibrated such that the concentration of the toner reaches a predetermined toner concentration, such as 6.5%. At step S700, the developer housing is toned up to allow the control for a calibration, such as a calibration using an optical tool. Optionally, at step S800, the calibrated toner concentration sensor may be adjusted using an optical tool. Then, the process ends at step S900.

It is apparent that these steps shown in FIG. 4 are described in above order for illustration purpose, and in various exemplary embodiments, the selection of the objects may be performed in different order and/or with any additional or fewer steps.

Each of the sections of the various exemplary embodiments of the toner concentration sensor controller 550 outlined above can be implemented as portions of a suitable programmed general purpose computer. Alternatively, each of the sections of the various exemplary embodiments of the toner concentration sensor controller 550 outlined above can be implemented as physically distinct hardware circuits within an ASIC, or using FPGA, a PDL, a PLA or a PAL, or using discrete logic elements or discrete circuit elements. The particular form each of the circuits and elements of the various exemplary embodiments of the toner concentration sensor controller 550 outlined above will take is a design choice and will be obvious and predicable to those skilled in the art.

Moreover, the various exemplary embodiments of the toner concentration sensor controller 550 outlined above and/or each of the various sections discussed above can each be implemented as software routines, managers or objects executing on a programmed general purpose computer, a special purpose computer, a microprocessor or the like. In this case, the various exemplary embodiments of the toner concentration sensor controller 550 and/or each or the various circuits and elements discussed above can each be implemented as one or more routines embedded in the communication network, as a resource residing on a server, or the like. The various exemplary embodiments of the toner concentration sensor controller 550 and the various sections discussed above can also be implemented by physically incorporated the toner concentration sensor controller 550 in to any software and/or hardware system.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of calibrating a toner concentration sensor, comprising:
obtaining a zero % TC reading of the toner concentration sensor based on a carrier material of a developer mix;
determining an estimated TC intercept for the developer mix; and
pre-calibrating a toner concentration of toner mixture based on the estimated TC intercept.

2. The method of claim 1, wherein the estimated TC intercept is determined by dividing the zero % TC reading by a first predetermined value and subtracting a second predetermined value from the division.

3. The method of claim 2, wherein the first and second predetermined values are pre-configured for the carrier material of the developer mix.

4. The method of claim 1, further comprising:
adjusting the calibrated toner concentration sensor.

5. The method of claim 4, wherein the toner concentration sensor is further adjusted using an optical tool.

6. The method of claim 1, further comprising:
detecting a new developer carrier material without any toner, wherein the zero % TC reading is obtained after the detection of the new developer carrier material.

7. The method of claim 6, wherein the new developer carrier material is configured be used with any toner, color or black.

8. An apparatus for calibrating a toner concentration sensor, comprising:
a toner concentration sensor that detects toner concentration of a developer mix in a developer cartridge; and
a toner concentration sensor controller that applies a calibration to the toner concentration sensor, including:
a reading section that obtains a zero % TC reading of the toner concentration sensor based on a carrier material of the developer mix,
a determining section that determines an estimated TC intercept for the developer mix; and
a pre-calibrating section that adjusts the toner concentration of the developer mix based on the estimated TC intercept.

9. The apparatus of claim 8, wherein the determining section determines the estimated TC intercept by dividing the zero % TC reading by a first predetermined value and subtracting a second predetermined value from the division.

10. The apparatus of claim 9, the first and second predetermined values are pre-configured for the carrier material.

11. The apparatus of claim 8, further comprising:
an optical tool configured to further adjust the calibrated toner concentration sensor.

12. The apparatus of claim 8, further comprising:
a carrier material detecting section that detects a newly installed developer carrier material, wherein the reading section obtains the zero % TC reading after the carrier material detecting section detects the newly installed developer carrier material.

13. The apparatus of claim 8, wherein the carrier material is a carrier for custom color.

14. A system for calibrating a toner concentration, comprising:
a toner cartridge containing a developer mix;
a toner concentration sensor apparatus, comprising:
a toner concentration sensor that detects toner concentration of a developer mix in a developer housing; and
a toner concentration sensor controller that applies a calibration to the toner concentration sensor, including
a reading section that obtains a zero % TC reading of the toner concentration sensor based on a carrier material;
a determining section that determines an estimated TC intercept for the developer mix; and
a pre-calibrating section that adjusts the toner concentration of the developer mix based on the estimated TC intercept.

15. The system of claim 14, wherein the determining section determines the estimated TC intercept by dividing the zero % TC reading by a first predetermined value and subtracting a second predetermined value from the division.

16. The system of claim 14, the first and second predetermined values are pre-configured for the carrier material.

17. The system of claim 14, further comprising:
an optical tool configured to further adjust the calibrated toner concentration sensor.

18. The system of claim 14, further comprising:
a carrier material detecting section that detects a newly installed developer carrier material, wherein the reading section obtains the zero % TC reading after the carrier material section detects the newly installed developer carrier material.

19. The system of claim 18, wherein the carrier material is a carrier material for custom color.

20. A xerographic device including the apparatus of claim 8.
